(19) United States
(12) Patent Application Publication
(10) Pub. No.: US 2018/0190167 A1
(43) Pub. Date: Jul. 5, 2018

(54) DISPLAY SYSTEM

(71) Applicant: Siena Technolgoy Limited, Hong Kong (CN)

(72) Inventor: Charn-Hang Cliff CHAN, Hong Kong (CN)

(21) Appl. No.: 15/741,534

(22) PCT Filed: Jul. 1, 2016
(86) PCT No.: PCT/CN2016/088136

§ 371 Date: Jan. 3, 2018

(30) Foreign Application Priority Data
Jul. 3, 2015 (HK) 15106360.2

(51) Int. Cl. G09G 3/00; G06F 3/041; G06F 3/0484

(52) U.S. Cl. CPC G09G 3/002; G06F 3/04847; G06F 3/0412

(57) ABSTRACT

A display system (1) comprising a projector (2) for projecting visual content, and an adjustable opacity display (3) switchable between a transparent state and a high opacity state such that when visual content is projected from the projector (2) onto the display (3) in the high opacity state the visual content is visible on the display (3). A sensor (4) is configured to detect a user input from a user interacting with the display (3). A control module (5) is configured to perform one or more of the following depending on the user input: switching the display (3) between the transparent and high opacity states, projecting visual content onto the display (3), and interacting with the visual content projected onto the display (3).

### TECHNICAL FIELD

The invention relates to display systems, and in particular, display systems for displaying content on transparent panels.

### BACKGROUND ART

Display systems for displaying content on transparent panels such as windows are becoming increasingly popular. Prior systems employ transparent panels laminated or treated so that the panel has a degree of opacity to allow a projected image to be visible on the panel. However, such systems will always be a compromise between the visibility of the projected image and of the scene behind the transparent panel. In particular, a higher opacity panel will provide a clearer projected image but a more obscured scene behind the panel. A lower opacity panel will provide a clearer scene behind the panel but a less visible projected image. The optimum degree of opacity will also vary depending on the ambient lighting conditions which can vary.

Other prior systems employ switchable glass panels. However, these are inflexible as they need to be switched to between a high opacity state in which visual content projected onto the panel will be visible but the scene behind the panel will be hidden, and a transparent state in which the scene behind the panel will be visible but visual content projected onto the panel will not be sufficiently visible. The switching is usually carried out manually or in accordance with a pre-programmed schedule. This is not suitable for situations in which the need switch between displaying visual content and revealing the scene behind the panel is dynamic or is dictated by viewers of the panel.

It is an object of the present invention to overcome or ameliorate at least one of the disadvantages of the prior art, or to provide a useful alternative.

### DISCLOSURE OF INVENTION

### Solution to Problem

### Technical Solution

The present invention provides, in one aspect, a display system comprising:

a projector for projecting visual content;

an adjustable opacity display switchable between a transparent state and a high opacity state such that when visual content is projected from the projector onto the display in the high opacity state the visual content is visible on the display;

a sensor configured to detect a user input from a user interacting with the display; and

a control module configured to perform one or more of the following depending on the user input: switching the display between the transparent and high opacity states, projecting visual content onto the display, and interacting with the visual content projected onto the display.

In one embodiment, a plurality of portions of the display are independently switchable between the transparent and high opacity states.

In one embodiment, one or more of the following characteristics of the portions are adjustable: location, dimensions, shape. In one embodiment, the control module adjusts the characteristics in accordance with a preset program or the user input.

In one embodiment, the control module switches the portions of the display between the transparent and high opacity states in accordance with a preset program or the user input.

In one embodiment, a plurality of portions of the display are sequentially switchable between the transparent and high opacity states.

In one embodiment, the control module switches the portions of the display between the transparent and high opacity states in coordination with changes in the visual content. In one embodiment, the control module switches the portions of the display between the transparent and high opacity states such that the visual content moves from a previous portion in the high opacity state to a next portion in the high opacity state, the visual content thereby appearing to move across the display. In one embodiment, the next portion switches to the high opacity state once the previous portion switches to the transparent state.

In one embodiment, one or more of the following characteristics of the high opacity state is variable: colour, tint, shade, tone, degree of opacity.

In one embodiment, the adjustable opacity display is switchable glass or switchable laminate on a transparent panel.

In one embodiment, the sensor is a touch sensor and the user input is a touch input on or adjacent the display. In one embodiment, the touch sensor comprises an emitter and a receiver, the emitter emitting non-visible radiation across the display for receipt by the receiver, the touch input being detected when an input object is placed on or adjacent the display thereby interfering with the non-visible radiation. In one embodiment, the emitter is located at or near a first periphery of the display, and the receiver is located at or near a second periphery of the display opposing the first periphery.

In one embodiment, the touch sensor comprises a plurality of said emitters and a plurality of said receivers arranged in a first linear array and a second linear array, the first linear array comprising emitters or a combination of emitters and receivers, the second linear array comprising receivers or a combination of emitters and receivers, each emitter emitting non-visible radiation across the display for receipt by one or more of the receivers. In one embodiment, the display is rectangular and the first linear array is located along or adjacent a first edge of the display, and the second linear array located along or adjacent a second edge of the display opposite the first edge.

In one embodiment, the touch sensor comprises a third linear array comprising emitters or a combination of emitters and receivers, a fourth linear array comprising receivers or a combination of emitters and receivers, the third linear array being located along or adjacent a third edge of the display, and the fourth linear array being located along or adjacent a fourth edge of the display opposite the third edge.

In one embodiment, the non-visible radiation is infrared radiation.

In another embodiment, the sensor is a motion sensor and the user input is a motion input defined by one or more movements of the user.

In one embodiment, the control module communicates wirelessly with one or more of the following: the projector, the display, the sensor.

In one embodiment, the control module is one or a combination of the following: a desktop computer, a laptop computer, a tablet computer, a handheld device, a smartphone, a microprocessor embedded in one of the other components of the display system, a remote control module.

### Advantageous Effects of Invention

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### BRIEF DESCRIPTION OF DRAWINGS

Preferred embodiments in accordance with the best mode of the present invention will now be described, by way of example only, with reference to the accompanying figures, in which the same reference numerals refer to like parts throughout the figures unless otherwise specified, and in which:

FIG. 1 is a schematic diagram of a display system in accordance with an embodiment of the present invention;

FIG. 2 is schematic diagram of an embodiment of the adjustable opacity display and sensor of the display system of FIG. 1; and

FIG. 3 is schematic diagram of another embodiment of the adjustable opacity display and sensor of the display system of FIG. 1.

### MODE FOR THE INVENTION

Referring to the figures, there is provided a display system 1 comprising a projector 2 for projecting visual content, and an adjustable opacity display 3 switchable between a transparent state and a high opacity state such that when visual content is projected from the projector 2 onto the display 3 in the high opacity state the visual content is visible on the display. A sensor 4 is configured to detect a user input from a user interacting with the display 3. A control module 5 is configured to perform one or more of the following depending on the user input: switching the display 3 between the transparent and high opacity states, projecting visual content onto the display, and interacting with the visual content projected onto the display.

In the high opacity state, the opacity of the display 3 is such that in a given ambient light condition, the display has sufficient opacity so that the visual content projected by the projector 2 onto the display 3 is visible on the display to viewers viewing the display.

The projector 2 is any device that can project visual content onto a surface. Accordingly, the projector can be in the form of, for example, a dedicated projection device, a pico projector, or a still or video camera with projector functionality.

The adjustable opacity display 3 is switchable glass or switchable laminate on a transparent panel. The transparent panel can be of any transparent material suitable for the intended application, and includes glass, Perspex, other transparent polymer materials, transparent ceramics, and transparent crystalline materials.

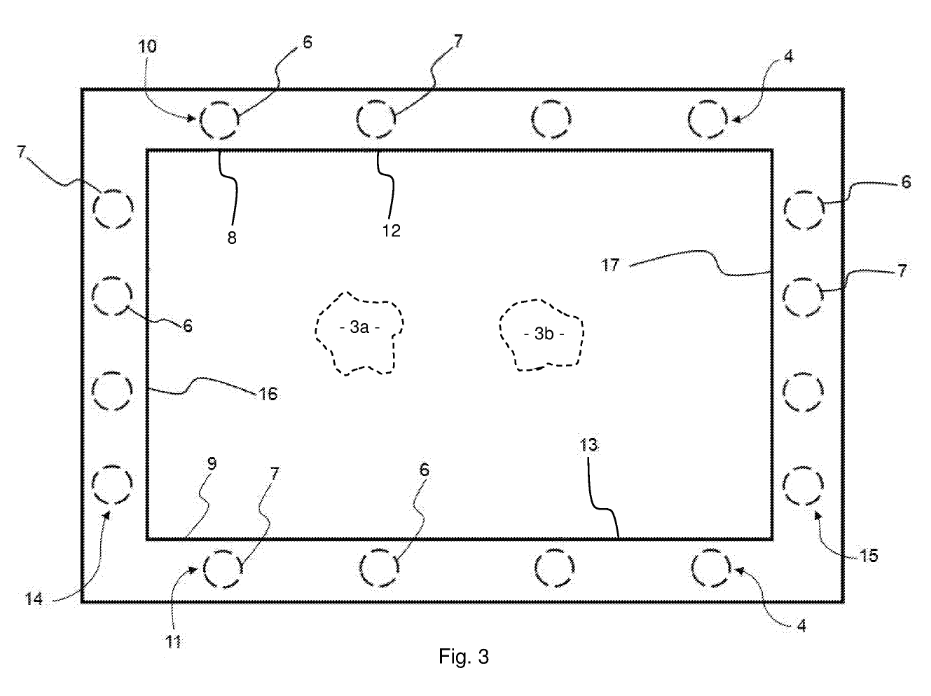

In one embodiment, substantially the whole of the display 3 or one portion of the display is switchable between the transparent and high opacity states. In another embodiment, as best shown in FIG. 3, a plurality of portions 3a, 3b, etc. of the display 3 are independently switchable between the transparent and high opacity states. The portions can be of any shape, such as rectangular or even an irregular shape. For example, the adjustable opacity display 3 can be formed of switchable laminate in separate small square units laminated onto a transparent substrate. The portions 3a, 3b, etc. can be formed from one or more of these units to define various shapes.

One or more of the following characteristics of the portions are adjustable: location, dimensions, shape. The control module 5 adjusts the characteristics in accordance with a preset program or the user input. The control module 5 can also adjust the characteristics in coordination with changes in the visual content. For example, as the visual content changes in size, the dimensions and therefore size of the portion onto which the visual content is projected changes corresponding to the change in size of the visual content. As another example, the user provides user input to enlarge the portion so that more of the visual content can be displayed when the portion is switched to the high opacity state.

The control module 5 switches the portions of the display 3 between the transparent and high opacity states in accordance with a preset program or the user input. For example, the user provides user input to switch one or more portions of the display 3 from the transparent state to the high opacity state to reveal the visual content.

In one embodiment, the control module 5 switches the portions of the display 3 between the transparent and high opacity states in coordination with changes in the visual content. For example, the control module 5 switches the portions of the display 3 between the transparent and high opacity states such that the visual content moves from a previous portion in the high opacity state to a next portion in the high opacity state, the visual content thereby appearing to move across the display 3. In one particular example, the next portion switches to the high opacity state once the previous portion switches to the transparent state. In this way, only the portion displaying the visual content is in the high opacity state, whilst the remaining portions are in the transparent state. In some embodiments, there can be a number of portions in the high opacity state so that a larger area of visual content can be displayed. The control module 5 switches the portions between the transparent and high opacity states such that the visual content moves from one or more portions in the high opacity state to one or more next portions in the high opacity state, the visual content thereby appearing to move across the display 3. As noted before, the one or more next portions switch to the high opacity state once the one or more previous portions switch to the transparent state.

This is particularly useful for visual content that includes moving objects. For example, a ball can be shown to be bouncing across the display 3. The ball is first projected onto a first portion in the high opacity state, whilst the remaining portions are in the transparent state. The ball is then projected onto an adjacent portion which switches to the high opacity state as the first portion switches to the transparent state. The ball is then projected onto subsequent adjacent portions which sequentially switch to the high opacity state whilst the previous portions sequentially switch to the transparent state. The ball thereby appears to move across the display 3.

Another application is where the visual content is made to look as though it is disappearing and re-appearing at another location on the display 3. The visual content can be the same or can change between locations.

In another embodiment, a plurality of portions of the display 3 are sequentially switchable between the transparent and high opacity states. One application of this embodiment is the effect of “blinds”. For example, the plurality of portions are in the form of adjacent vertical strips. In an initial condition, all of the strips are in the transparent state. The leftmost strip then switches to the high opacity state. The adjacent strip to the right then switches to the high opacity state. This process repeats until all of the strips switch to the high opacity state. This has the effect of a high opacity “blind” being drawn closed from left to right across the display 3. This can be used to draw a blind to gradually hide the scene behind the initially transparent display 3. Alternatively, this can be used to gradually reveal the visual content being projected onto the strip portions switched to the high opacity state.

The reverse effect can also be provided by initially having all of the strips in the high opacity state. The leftmost strip then switches to the transparent state. The adjacent strip to the right then switches to the transparent state. This process repeats until all of the strips switch to the transparent state. This has the effect of a high opacity “blind” being drawn open from left to right across the display 3. This can be used to draw a blind to gradually reveal the scene behind the initially high opacity display 3. Alternatively, this can be used to gradually hide the visual content being projected onto the strip portions in the high opacity state.

It is appreciated that other arrangements of “blinds” are possible. For example, the plurality of portions can be in the form of adjacent horizontal strips, whereby the blind can be drawn in the up-down direction on the display 3. The plurality of portions can be in the form of adjacent diagonal strips, whereby the blind can be drawn in a diagonal direction. The plurality of portions can be in the form of adjacent concentric annular strips, whereby the blind can be drawn from the centre of the display 3 to the outer edges and vice versa. Also, instead of the “blinds” being drawn in one direction, they can be drawn in multiple directions. For example, with vertical or horizontal blinds, the blinds can be drawn from two opposing sides towards the centre, or vice versa, from the centre towards two opposing sides.

One or more of the following characteristics of the high opacity state is variable: colour, tint, shade, tone, degree of opacity. The control module 5 can adjust the characteristics in accordance with a preset program or the user input. The control module 5 can also adjust the characteristics in coordination with changes in the visual content. For example, how the degree of opacity is varied can depend on the ambient light conditions. In outdoor daylight or other bright ambient conditions, the degree of opacity in the high opacity state can be much higher than in indoor or darker conditions. The visual content projected onto the display 3 in the high opacity state will require a higher degree of opacity in brighter ambient conditions to be visible since the display will need to prevent more light coming from the other side of the display in such conditions. The degree of opacity can also be varied to provide one or more intermediate opacity states in which both the visual content is at least partially visible and the scene behind the display 3 is partially visible. Furthermore, the degree of opacity can be varied gradually to gradually reveal or gradually hide the scene behind the display 3, or conversely, gradually hide or gradually reveal the visual content projected onto the display 3.

In one embodiment, the sensor 4 is a touch sensor and the user input is a touch input on or adjacent the display 3. The touch sensor comprises an emitter 6 and a receiver 7. The emitter 6 emits non-visible radiation across the display 3 for receipt by the receiver 7, with the touch input being detected when an input object is placed on or adjacent the display thereby interfering with the non-visible radiation. The input object can be, for example, a user's finger or hand. The touch input being detected can be a single touch input or a multi-touch input. The touch sensor can detect gesture-type touch inputs. For example, placing two fingers on or adjacent the display 3 and then moving them together (i.e. pinching) can correspond to shrinking the visual content or part of the visual content, whilst moving the fingers apart can correspond to magnifying the visual content or part of the visual content.

The emitter 6 is located at or near a first periphery 8 of the display 3, and the receiver 7 is located at or near a second periphery 9 of the display opposing the first periphery 8.

In one embodiment, the touch sensor comprises a plurality of said emitters 6 and a plurality of said receivers 7 arranged in a first linear array 10 and a second linear array 11. The first linear array 10 comprises emitters 6 or a combination of emitters 6 and receivers 7, and the second linear array 11 comprises receivers 7 or a combination of emitters 6 and receivers 7, with each emitter 6 emitting non-visible radiation across the display 3 for receipt by one or more of the receivers 7.

Typically, but not exclusively, the display 3 is rectangular and the first linear array 10 is located along or adjacent a first edge 12 of the display, and the second linear array 11 is located along or adjacent a second edge 13 of the display opposite the first edge.

In some embodiments, the touch sensor comprises a third linear array 14 comprising emitters 6 or a combination of emitters 6 and receivers 7, and a fourth linear array 15 comprising receivers 7 or a combination of emitters 6 and receivers 7. The third linear array 14 is located along or adjacent a third edge 16 of the display 3, and the fourth linear array 15 is located along or adjacent a fourth edge 17 of the display opposite the third edge.

The non-visible radiation can be infrared radiation or any other suitable type of nonvisible radiation.

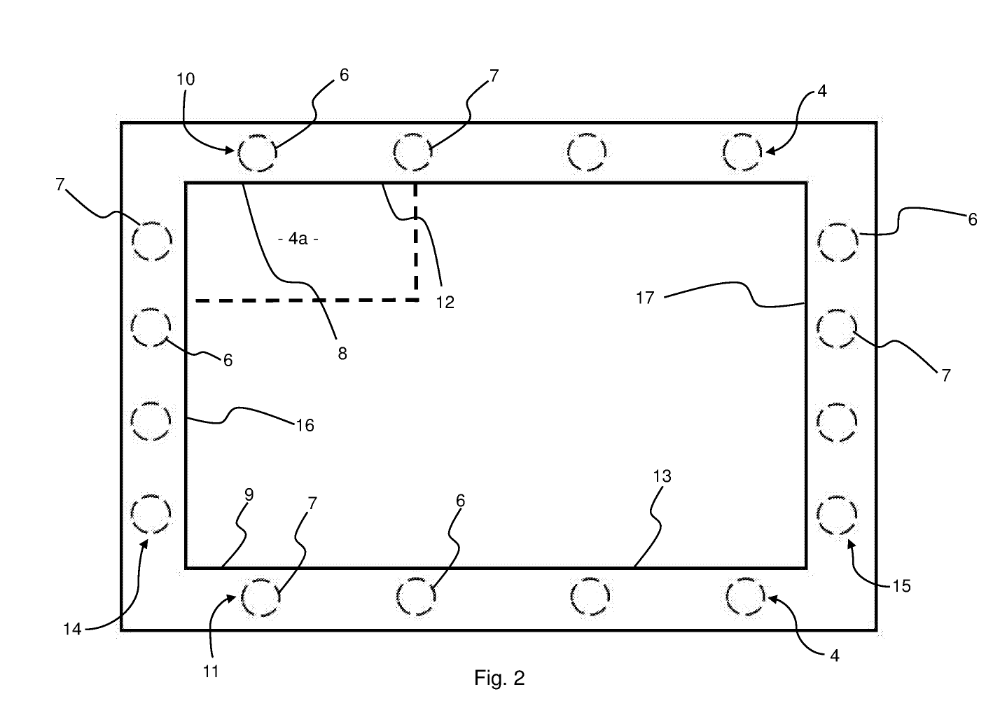

In one embodiment, the sensor 4 only detects touch inputs in one or more active areas 4a of the display 3, with the remaining area of the display being inactive in terms of detecting touch inputs. This is best shown in FIG. 2. This can be done by controlling the sensor 4 so that only the emitters 6 and receivers 7 covering the one or more active areas 4a are operating. The remaining emitters 6 and receivers 7 can be placed into an inoperative condition or touch inputs detected by the remaining emitters 6 and receivers 7 can be ignored. Alternatively, the display system 1 can be provided with a sensor 4 that only covers the one or more active areas 4a. For example, FIG. 2 shows one active area 4a in the top left hand corner of the display 3. The first and second linear arrays 10 and 11, and the third and fourth linear arrays 14 and 15 if they exist, are only of a length that allows the active area 4a to be covered. This is useful in applications where it is desirable to restrict the user input from users to one or more specific active areas 4a. The remaining area can remain in the transparent state, or can remain in the high opacity state with or without visual content which of course the user will not be able to interact with.

In another embodiment, the sensor 4 is a motion sensor and the user input is a motion input defined by one or more movements of the user. The motion sensor can be a camera with associated software to recognize movements of the user. The camera can be a thermal camera, an infrared camera, or even a camera operating on the normal visual spectrum.

The control module 5 can communicate wirelessly with one or more of the following: the projector, the display, the sensor. The control module can be one or a combination of the following: a relay switch, a desktop computer, a laptop computer, a tablet computer, a handheld device, a smartphone, a microprocessor embedded in one of the other components of the display system, a remote control module.

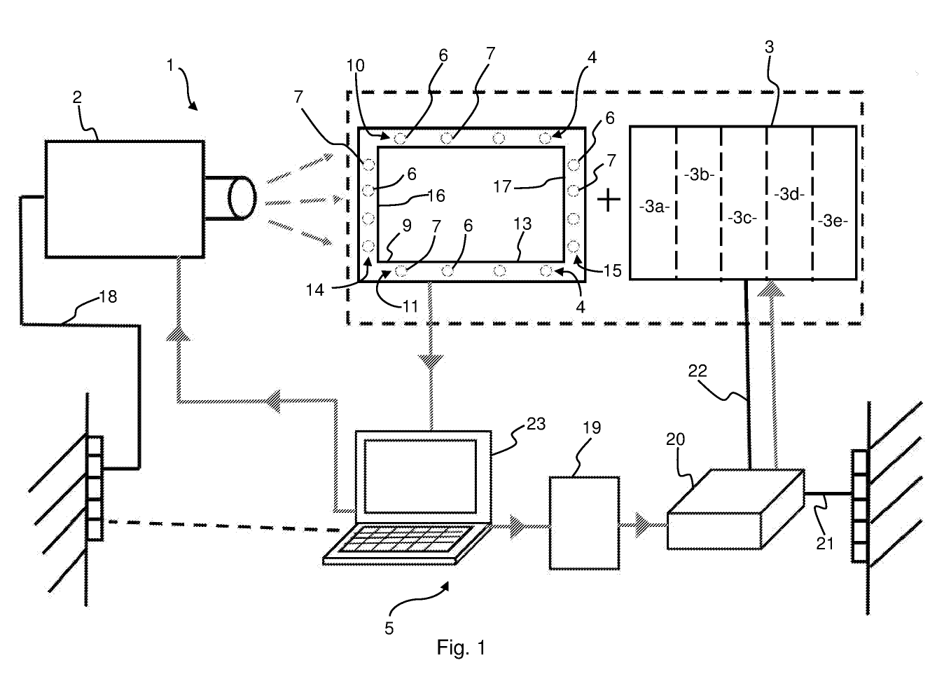

In the display system depicted in FIG. 1, the control module 5 includes a computing device 23 such as a desktop personal computer, a laptop computer, or a tablet computer. The control module 5 communicates with the projector 2 wirelessly using a protocol such as wi-fi, Bluetooth, infrared, 3G, 4G, Zigbee, or other cellular mobile communications protocol. The projector is powered by mains power through a power cable 18. The control module 5 also includes a relay switch 19 which communicates with the display 3 through a power supply 20. The relay switch 19 can be a USB relay switch.

The control module 5 can be packaged in various arrangements. For example, the relay switch 19 can be provided together with the power supply 20 as a single package. This is advantageous in embodiments where the computing device is supplied by another party, or where the control module 5 does not include a computing device 23, but only the relay switch 19 by itself or the relay switch 19 with other components. In the latter embodiments where the control module 5 does not include the computing device 23, a computing device 23 can still be connected and used for configuring the control module 5, such as during initial setup, when the configuration of the control module needs to be changed, or for diagnostic activities. The relay switch 19 with or without other associated components can of course be provided by itself as a separate package. In embodiments where the computing device 23 forms part of the control module 5, the computing device 23 and the relay switch 19 can be provided as a single package. Alternatively, the control module 5 can be provided as a package including the computing device 23, the relay switch 19, and the power supply 20.

In other embodiments, the control module 5 can communicate with the display 3 wirelessly using a protocol such as wi-fi, Bluetooth, infrared, 3G, 4G, Zigbee, or other cellular mobile communications protocol. The power supply 20 is connected to mains power through power cable 21. The power supply 20 in turn powers the display 3 through power cable 22. The sensor 4 is also powered by the power supply 20 through the power cable 22. In other embodiments, the sensor can be powered by other means, such as via a USB port on the computing device 23. The sensor 4 communicates with the control module wirelessly using a protocol such as wi-fi, Bluetooth, infrared, 3G, 4G, Zigbee, or other cellular mobile communications protocol. The sensor 4 is a touch sensor in the form of a frame around the display 3. The power supply 20 can also be configured to provide power to the projector 2 if this is advantageous in packaging the display system 1 together.

It is appreciated that the aforesaid embodiments are only exemplary embodiments adopted to describe the principles of the present invention, and the present invention is not merely limited thereto. Various variants and modifications can be made by those of ordinary skill in the art without departing from the spirit and essence of the present invention, and these variants and modifications are also covered within the scope of the present invention. Accordingly, although the invention has been described with reference to specific examples, it is appreciated by those skilled in the art that the invention can be embodied in many other forms. It is also appreciated by those skilled in the art that the features of the various examples described can be combined in other combinations.

1. A display system comprising:
a projector for projecting visual content;
an adjustable opacity display switchable between a transparent state and a high opacity state such that when visual content is projected from the projector onto the display in the high opacity state the visual content is visible on the display;
a sensor configured to detect a user input from a user interacting with the display; and
a control module configured to perform one or more of the following depending on the user input: switching the display between the transparent and high opacity states, projecting visual content onto the display, and interacting with the visual content projected onto the display.

2. A display system according to claim 1 wherein a plurality of portions of the display are independently switchable between the transparent and high opacity states.

3. A display system according to claim 2 wherein one or more of the following characteristics of the portions are adjustable: location, dimensions, shape.

4. A display system according to claim 3 wherein the control module adjusts the characteristics in accordance with a preset program or the user input.

5. A display system according to claim 2 wherein the control module switches the portions of the display between the transparent and high opacity states in accordance with a preset program or the user input.

6. A display system according to claim 2 wherein a plurality of portions of the display are sequentially switchable between the transparent and high opacity states.

7. A display system according to claim 2 wherein the control module switches the portions of the display between the transparent and high opacity states in coordination with changes in the visual content.

8. A display system according to claim 2 wherein the control module switches the portions of the display between the transparent and high opacity states such that the visual content moves from a previous portion in the high opacity state to a next portion in the high opacity state, the visual content thereby appearing to move across the display.

9. A display system according to claim 8 wherein the next portion switches to the high opacity state once the previous portion switches to the transparent state.

10. A display system according to claim 1 wherein one or more of the following characteristics of the high opacity state is variable: colour, tint, shade, tone, degree of opacity.

11. A display system according to claim 1 wherein the adjustable opacity display is switchable glass or switchable laminate on a transparent panel.

12. A display system according to claim 1 wherein the sensor is a touch sensor and the user input is a touch input on or adjacent the display.

13. A display system according to claim 12 wherein the touch sensor comprises an emitter and a receiver, the emitter emitting non-visible radiation across the display for receipt by the receiver, the touch input being detected when an input object is placed on or adjacent the display thereby interfering with the non-visible radiation.

14. A display system according to claim 13 wherein the emitter is located at or near a first periphery of the display, and the receiver is located at or near a second periphery of the display opposing the first periphery.

15. A display system according to claim 13 wherein the touch sensor comprises a plurality of said emitters and a plurality of said receivers arranged in a first linear array and a second linear array, the first linear array comprising emitters or a combination of emitters and receivers, the second linear array comprising receivers or a combination of emitters and receivers, each emitter emitting non-visible radiation across the display for receipt by one or more of the receivers.

16. A display system according to claim 15 wherein the display is rectangular and the first linear array is located along or adjacent a first edge of the display, and the second linear array located along or adjacent a second edge of the display opposite the first edge.

17. A display system according to claim 16 wherein the touch sensor comprises a third linear array comprising emitters or a combination of emitters and receivers, a fourth linear array comprising receivers or a combination of emitters and receivers, the third linear array being located along or adjacent a third edge of the display, and the fourth linear array being located along or adjacent a fourth edge of the display opposite the third edge.

18. A display system according to claim 13 wherein the non-visible radiation is infrared radiation.

19. A display system according to claim 1 wherein the sensor is a motion sensor and the user input is a motion input defined by one or more movements of the user.

20. A display system according to claim 1 wherein the control module communicates wirelessly with one or more of the following: the projector, the display, the sensor.

21. (canceled)
